(19) United States
(12) Patent Application Publication
(10) Pub. No.: US 2014/0375257 A1
(43) Pub. Date: Dec. 25, 2014

(54) NON-CONTACT CHARGING SYSTEM AND NON-CONTACT CHARGING METHOD

(71) Applicant: RENESAS ELECTRONICS CORPORATION, Kanagawa (JP)

(72) Inventors: Kyoji AKIYAMA, Tokyo (JP); Toshiki YAMAHIRA, Tokyo (JP)

(73) Assignee: RENESAS ELECTRONICS CORPORATION, Kanagawa (JP)

(21) Appl. No.: 14/288,546

(22) Filed: May 28, 2014

(30) Foreign Application Priority Data
Jun. 21, 2013 (JP) 2013-130835

(51) Int. Cl. H02J 7/02

(52) U.S. Cl. CPC H02J 7/025; H02J 7/007
USPC 320/108; 320/137

(57) ABSTRACT

The present invention provides a non-contact charging system which can transmit the information on the reception state from an electric power receiving device to an electric power transmitting device while performing the electric power reception. The non-contact charging system is configured with an electric power transmitting device which performs electric power transmission at a resonance frequency and an electric power receiving device which performs electric power reception at the resonance frequency. The electric power receiving device includes an adjustment unit which can adjust the resonance frequency; and a receiving-side control unit for adjusting the resonance frequency when a prescribed condition is satisfied. The electric power transmitting device includes a reflected wave detection unit which detects a reflected wave from the electric power receiving device; an extraction unit which extracts reception information included in the reflected wave; and a transmitting-side control unit which controls the electric power transmission.

### CROSS-REFERENCE TO RELATED APPLICATIONS

The disclosure of Japanese Patent Application No. 2013-130835 filed on Jun. 21, 2013 including the specification, drawings and abstract is incorporated herein by reference in its entirety.

### BACKGROUND

The present invention relates to a non-contact charging system and a non-contact charging method for performing the electric power transmission and reception with the use of magnetic resonance.

As the wireless electric power supply technology, the technology using electromagnetic induction and the technology using a radio wave are generally known. In contrast with this, the technology using magnetic resonance is proposed in recent years (for example, refer to Patent Literature 1).

In the wireless electric power supply technology using magnetic resonance, for example, a transmitting resonance coil with a resonance frequency fr1 is provided in an electric power transmitting device, and a receiving resonance coil with a resonance frequency fr2 is provided in an electric power receiving device. By tuning the resonance frequencies fr1 and fr2 of these coils and by adjusting the size and the arrangement appropriately, a coupling state of the magnetic field occurs, allowing energy transmission by magnetic resonance between the electric power transmitting device and the electric power receiving device. Accordingly, electric power is transmitted by radio from the transmitting resonance coil of the electric power transmitting device to the receiving resonance coil of the electric power receiving device.

### PATENT LITERATURE

(Patent Literature 1) Published Japanese Unexamined Patent Application No. 2013-5527

### SUMMARY

On the other hand, according to the patent literature cited above, when electric charging is completed, it is possible to notify the electric power transmitting device of the completion of the electric charging, by changing the resonance frequency of the receiving resonance coil. However, it is difficult to notify the electric power transmitting device of the reception state and others of the electric power receiving device during the electric charging.

If it is required to notify the information, it is necessary to stop the electric power transmission from the electric power transmitting device, in order to transmit the information from the electric power receiving device to the electric power transmitting device.

In order to solve problems such as described above, the present invention aims at providing a non-contact charging system and a non-contact charging method in which it is possible to transmit the information on the reception state from an electric power receiving device to an electric power transmitting device by a simple means, while performing the electric power reception.

The other issues and new features of the present invention will become clear from the description of the present specification and the accompanying drawings.

According to one embodiment, a non-contact charging system is configured with an electric power transmitting device for performing electric power transmission at a resonance frequency by employing a transmitting resonance coil, and an electric power receiving device for performing electric power reception at the resonance frequency by employing a receiving resonance coil. The electric power receiving device includes an adjustment unit for adjusting the resonance frequency of the receiving resonance coil; and a receiving-side control unit for instructing the adjustment unit to adjust the resonance frequency in accordance with a prescribed pattern, when a prescribed condition is satisfied. The electric power transmitting device includes a reflected wave detection unit for detecting a reflected wave from the electric power receiving device accompanying the electric power transmission; an extraction unit for extracting reception information included in the reflected wave, detected by the reflected wave detection unit and changing with the adjustment of the resonance frequency; and a transmitting-side control unit for controlling the electric power transmission from the transmitting resonance coil, on the basis of the reception information extracted by the extraction unit.

According to one embodiment, it is possible to transmit the information on the reception state from the electric power receiving device to the electric power transmitting device by a simple means, while performing the electric power reception.

### BRIEF DESCRIPTION OF THE DRAWINGS

FIG. 1 is an explanatory drawing illustrating a non-contact charging system 1 according to the present embodiment;

FIG. 2 is an explanatory drawing illustrating the outline of a hardware configuration of an electric power transmitting device 10 and an electric power receiving device 20, according to the present embodiment;

FIG. 3 is an explanatory drawing illustrating signal communications between the electric power transmitting device 10 and the electric power receiving device 20;

FIG. 4 is a flow chart explaining processing in transmission control of the electric power transmitting device 10 according to the present embodiment;

FIG. 5 is an explanatory drawing illustrating an abnormality threshold and a communication threshold according to the present embodiment;

FIG. 6 is a flow chart explaining processing in reception control of the electric power receiving device 20 according to the present embodiment;

FIG. 7A is an explanatory drawing illustrating adjustment of a capacitance value of a variable capacitor 31 according to the present embodiment;

FIG. 7B is another explanatory drawing illustrating adjustment of a capacitance value of the variable capacitor 31 according to the present embodiment;

FIG. 8A is an explanatory drawing illustrating adjustment of a capacitance value of the variable capacitor according to a modified example of the present embodiment; and

FIG. 8B is another explanatory drawing illustrating adjustment of a capacitance value of the variable capacitor according to the modified example of the present embodiment.

### DETAILED DESCRIPTION

Hereinafter, the embodiment is explained in detail with reference to drawings. In the drawings, the same reference symbol will be attached to the same or corresponding part, and the explanation thereof will not be repeated.

(System Configuration)

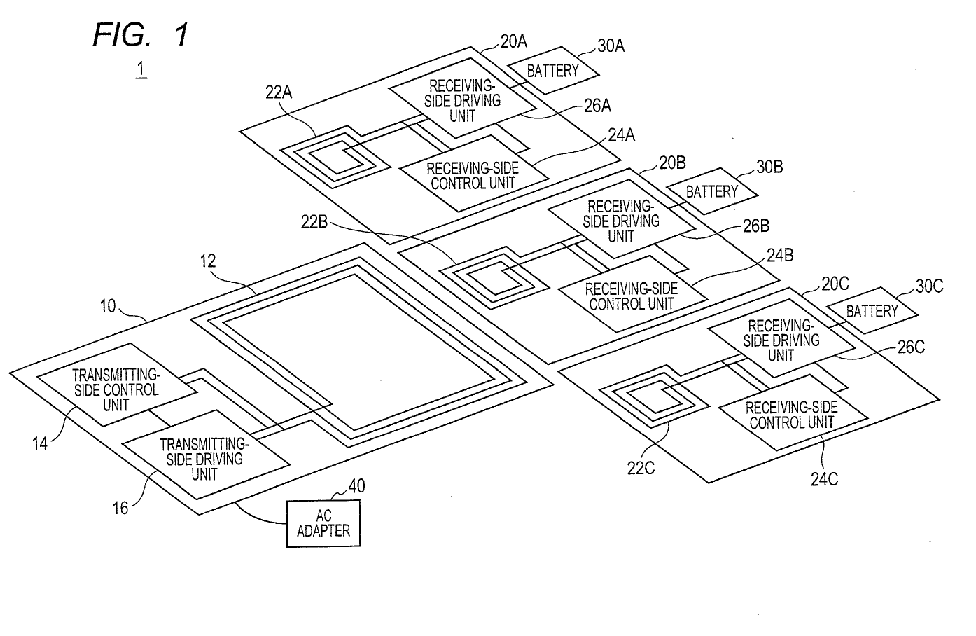

FIG. 1 is an explanatory drawing illustrating a non-contact charging system 1 according to the present embodiment.

According to the present embodiment, a non-contact charging system 1 which can charge multiple units of electric power receiving devices in a non-contact manner is explained with reference to FIG. 1.

In the present embodiment, the non-contact charging system 1 includes an electric power transmitting device 10 which transmits electric power; three units of electric power receiving devices 20A-20C (hereinafter, also collectively called an electric power receiving device 20) which receive an electric power from the electric power transmitting device 10; and batteries 30A-30C (secondary cells) which are provided respectively corresponding to the electric power receiving devices 20A-20C, and which charge the electric power received by each of the electric power receiving device 20. The present embodiment explains the case where three units of electric power receiving devices 20A-20C are provided to one unit of electric power transmitting device 10, as an example. However, it is not restricted to the present configuration in particular. It is also possible to adopt a configuration in which another electric power receiving device is further provided or a configuration in which only one unit of electric power receiving device is provided.

The electric power transmitting device 10 includes an antenna 12; a transmitting-side control unit 14 coupled to the antenna 12; and a transmitting-side driving unit 16 coupled to the antenna 12. The electric power transmitting device 10 is supplied with electric power from a power supply coupled to an AC adapter 40.

The transmitting-side control unit 14 controls the transmitting-side driving unit 16 to transmit electric power to the electric power receiving device 20 via the antenna 12, and at the same time, it can communicate with the electric power receiving device 20 via the antenna 12.

The electric power receiving devices 20A-20C include, respectively, antennae 22A-22C (hereinafter, also collectively called an antenna 22); receiving-side control units 24A-24C (hereinafter, also collectively called a receiving-side control unit 24) respectively coupled to the antennae 22A-22C; and receiving-side driving units 26A-26C (hereinafter, also collectively called a receiving-side driving unit 26) respectively coupled to the antennae 22A-22C. The receiving-side driving units 26A-26C are coupled respectively to batteries 30A-30C (hereinafter, also collectively called a battery 30) which charge the electric power received.

The receiving-side control unit 24 controls the receiving-side driving unit 26 to receive the electric power from the electric power transmitting device 10 via the antenna 22, and at the same time, it can communicate with the electric power transmitting device 10 via the antenna 22.

(Hardware Configuration)

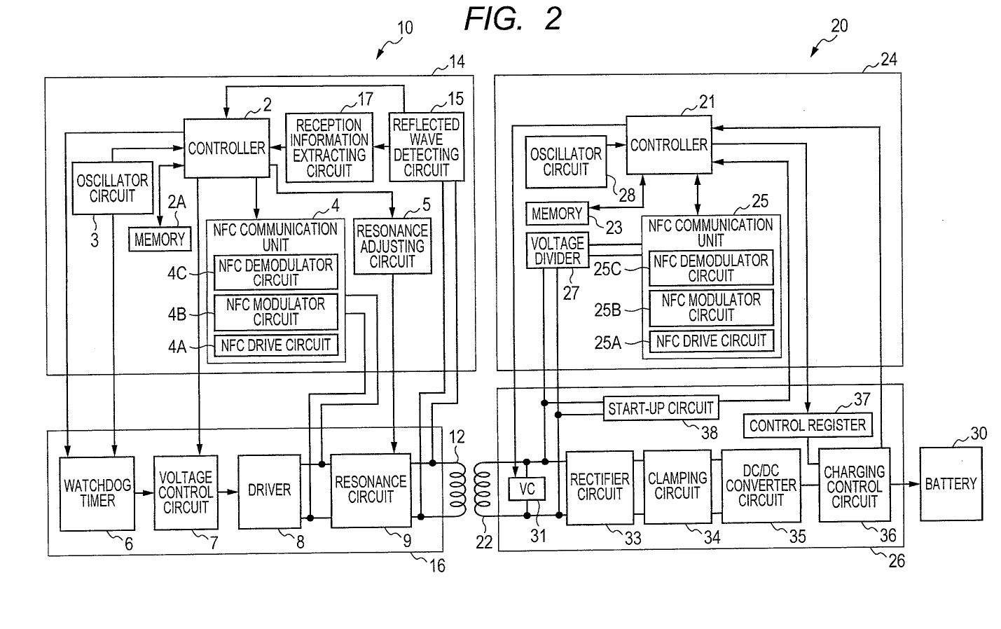

FIG. 2 is an explanatory drawing illustrating the outline of a hardware configuration of an electric power transmitting device 10 and an electric power receiving device 20, according to the present embodiment.

As illustrated in FIG. 2, the electric power transmitting device 10 is configured with the transmitting-side control unit 14, the transmitting-side driving unit 16, and the antenna 12 formed by a transmitting resonance coil.

The transmitting-side control unit 14 includes a controller 2 which controls the entire electric power transmitting device; a memory 2A; an oscillator circuit 3 which generates an internal clock for regulating the operation timing of each unit; an NFC communication unit 4 which carries out communications in an NFC system (NFC stands for Near Field Communication); a resonance adjusting circuit 5 which adjusts a resonance frequency of the transmitting resonance coil; a reflected wave detecting circuit 15; and a reception information extracting circuit 17.

The controller 2 instructs execution of various kinds of processing related to the electric power transmission, on the basis of a program stored in the memory 2A. The memory 2A is provided also as a working area. Various setting values are also stored in the memory 2A.

The NFC communication unit 4 includes an NFC drive circuit 4A; an NFC modulator circuit 4B; and an NFC demodulator circuit 4C.

The NFC modulator circuit 4B converts transmitting data outputted from the controller 2 into a modulated signal in conformity to an NFC protocol.

The NFC drive circuit 4A transmits the modulated signal outputted by the NFC modulator circuit 4B to the electric power receiving device 20 via the antenna 12.

The NFC demodulator circuit 4C demodulates a signal received via the antenna 12 and outputs the demodulated signal to the controller 2 as receive data.

The resonance adjusting circuit 5 adjusts the resonance frequency of the transmitting resonance coil according to the instruction from the controller 2.

The reflected wave detecting circuit 15 detects a reflected wave from the electric power receiving device 20. The reflected wave is generated at the time of electric power transmission from the electric power transmitting device 10 to the electric power receiving device 20.

The reception information extracting circuit 17 extracts information on the electric power reception (reception information) included in the reflected wave detected by the reflected wave detecting circuit 15.

The transmitting-side driving unit 16 includes a watchdog timer 6; a voltage control circuit 7; a driver 8; and a resonance circuit 9.

The watchdog timer 6 is clocked according to an internal clock outputted from the oscillator circuit 3, and outputs an instruction of exceptional treatment when an abnormal state occurs in the electric power transmitting on the transmitting side. An example of the exceptional treatment is to reset a system for the purpose of returning the system from a hang-up to the normal operation. In the case of the normal state, the time clocked by the watchdog timer 6 is reset according to the instruction from the controller 2. However, when there is no instruction from the controller, the watchdog timer 6 outputs the instruction of the exceptional treatment to the voltage control circuit 7. Following this, the voltage control circuit 7 stops the supply of voltage, that is, the voltage control circuit 7 stops the electric power transmission.

The voltage control circuit 7 controls the supply of a voltage from the AC adapter 40 to the driver 8 for driving, according to the instruction from the controller 2.

The driver 8 transmits the electric power to the electric power receiving device 20 via the antenna 12, according to the control instruction from the voltage control circuit 7.

The resonance circuit 9 generates magnetic resonance between the antenna 12 and the antenna 22, at a resonance frequency adjusted by the resonance adjusting circuit 5.

The electric power receiving device 20 is configured with a receiving-side control unit 24, a receiving-side driving unit 26, and the antenna 22 formed by a receiving resonance coil.

The receiving-side control unit 24 includes a controller 21 which controls the entire electric power receiving device; an oscillator circuit 28 which generates an internal clock for regulating the operation timing of each unit; an NFC communication unit 25 which carries out communications in the NFC system; a memory 23; and a voltage divider circuit 27.

The controller 21 carries out various kinds of processing according to a program stored in the memory 23. The memory 23 is provided also as a working area. Various setting values are also stored in the memory 23.

The voltage divider circuit 27 is coupled to the receiving resonance coil in parallel, subdivides a voltage received by the receiving resonance coil, and outputs it to the NFC communication unit 25.

The NFC communication unit 25 includes an NFC drive circuit 25A; an NFC modulator circuit 25B; and an NFC demodulator circuit 25C.

The NFC demodulator circuit 25C demodulates a signal received, via the antenna 22 and the voltage divider circuit 27, and outputs the demodulated signal to the controller 21 as receive data.

The NFC modulator circuit 25B converts transmitting data outputted from the controller 21 into a modulated signal in conformity to the NFC protocol.

The NFC drive circuit 25A transmits the modulated signal outputted by the NFC modulator circuit 25B to the electric power transmitting device 10 via the antenna 22.

The receiving-side driving unit 26 includes a variable capacitor (VC) 31 coupled to the receiving resonance coil in parallel; a rectifier circuit 33; a clamping circuit 34; a DC/DC converter circuit 35; a charging control circuit 36; a control register 37; and a start-up circuit 38. The charging control circuit 36 is coupled to the battery 30.

The variable capacitor (VC) 31 can change its capacitance value according to an applied voltage, and changes the capacitance value according to the voltage signal supplied by the controller 21. It is possible to adjust the resonance frequency by changing the capacitance value of the variable capacitor (VC) 31. It is also possible to reduce the layout by employing the variable capacitor.

The rectifier circuit 33 rectifies the electric power received by the antenna 22 to generate a direct-current voltage. The clamping circuit 34 performs clamping of the voltage rectified by the rectifier circuit 33 when it is an overvoltage, in order to protect the internal circuit.

The DC/DC converter circuit 35 converts the direct-current voltage into a prescribed voltage with which the charging control circuit 36 performs charging.

The charging control circuit 36 charges the battery 30 with the prescribed voltage converted by the DC/DC converter circuit 35. The charging control circuit 36 monitors the charging state of the battery 30, and outputs the state to the controller 21.

The control register 37 holds the various setting parameters which the charging control circuit 36 uses when performing charge control to the battery 30 according to the instruction from the controller 21. According to the various setting parameters, the charging control circuit 36 performs the charge control to the battery 30.

The start-up circuit 38 is coupled to the antenna 22, and activated in response to a start-up signal (to be described later) which is received via the antenna 22, and instructs the starting to the controller 21.

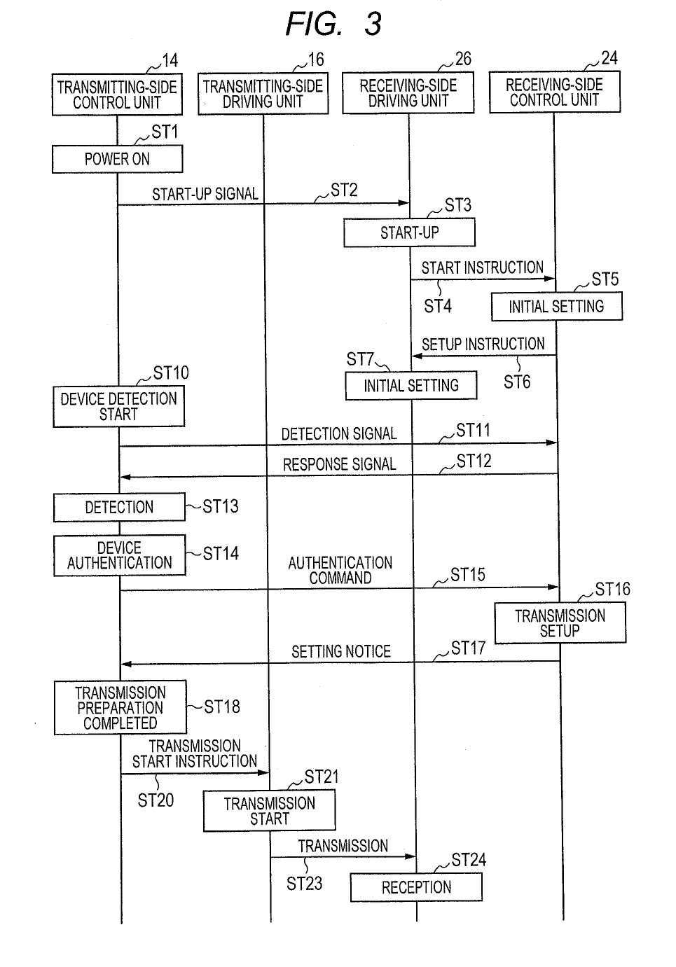

FIG. 3 is an explanatory drawing illustrating signal communications between the electric power transmitting device and the electric power receiving device 20. FIG. 3 illustrates the relation among the transmitting-side control unit 14, the transmitting-side driving unit 16, the receiving-side driving unit 26, and the receiving-side control unit 24.

In the transmitting-side control unit 14, the power is turned on (power ON) by a power switch, etc. (not shown) (Step ST1). In response to the power ON, the transmitting-side control unit 14 and the transmitting-side driving unit 16 are both set to an initial state.

Then, the transmitting-side control unit 14 transmits a start-up signal to the receiving-side driving unit 26 (Step ST2). Specifically, the controller 2 instructs the NFC communication unit 4 to transmit the start-up signal. The NFC modulator circuit 4B of the NFC communication unit 4 modulates the transmitting data according to the instruction from the controller 2, and the NFC drive circuit 4A transmits the modulated start-up signal via the antenna 12.

Then, the receiving-side driving unit 26 receives the start-up signal transmitted from the transmitting-side control unit 14 and starts (Step ST3). Specifically, the start-up circuit 38 receives the start-up signal and starts.

Then, the receiving-side driving unit 26 notifies the receiving-side control unit 24 (Step ST4) of a start instruction. Specifically, the start-up circuit 38 notifies the controller of the receiving-side control unit 24 of the start instruction.

Accordingly, the receiving-side control unit 24 executes initialization processing (Step ST5). Specifically, the controller 21 instructs each unit to become in an initial state.

The receiving-side control unit 24 instructs the receiving-side driving unit 26 to perform initial setting (Step ST6). The controller 21 instructs each unit of the receiving-side driving unit 26 to become in an initial state.

The receiving-side driving unit 26 executes initialization processing in response to the notice (Step ST7). By the processing, the electric power transmitting device 10 and the electric power receiving device 20 are activated, and each of the units thereof are initialized.

Next, the transmitting-side control unit 14 starts device detection processing (Step ST10). First, the transmitting-side control unit 14 transmits a detection signal to the receiving-side control unit 24 (Step ST11). Specifically, the controller 2 instructs the NFC communication unit 4 to transmit the detection signal. The NFC modulator circuit 4B of the NFC communication unit 4 modulates the transmitting data according to the instruction from the controller 2, and the NFC drive circuit 4A transmits the modulated detection signal via the antenna 12.

Then, the receiving-side control unit 24 receives the detection signal transmitted from the transmitting-side control unit 14, and transmits a response signal to the transmitting-side control unit 14 (Step ST12). Specifically, the NFC demodulator circuit 25C of the NFC communication unit 25 demodulates the detection signal transmitted from the transmitting-side control unit 14 and notifies the demodulated detection signal to the controller 21. Then, the controller 21 instructs the NFC communication unit 25 to transmit the response signal for the detection signal. The NFC modulator circuit 25B of the NFC communication unit 25 modulates the response signal according to the instruction from the controller 21, and the NFC drive circuit 25A transmits the modulated response signal via the antenna 22.

Then, the transmitting-side control unit 14 detects a device according to the response signal transmitted from the receiving-side control unit 24 (Step ST13).

Specifically, as the device detection processing, the transmitting-side control unit 14 detects which classification of the NFC communication is possible for the device. In regard to this matter, plural communication types are specified as the type of the NFC communication. In order to determine which of the NFC communication of Type A, Type B, and Type F is possible, as an example, the detection signal corresponding to each communication system is transmitted.

Accordingly, the transmitting-side control unit 14 can determine the type of device of the NFC communication according to the response signal transmitted from the receiving-side control unit 24 in response to the detection signal.

Next, the transmitting-side control unit 14 starts device authentication processing (Step ST14). First, the transmitting-side control unit 14 transmits an authentication command to the receiving-side control unit 24 (Step ST15). Specifically, the controller 2 instructs the NFC communication unit 4 to transmit the authentication command which includes the information related to the electric power transmission, such as transmission time and transmission output power. The NFC modulator circuit 4B of the NFC communication unit 4 modulates the authentication command according to the instruction from the controller, and the NFC drive circuit 4A transmits the modulated authentication command via the antenna 12.

Then, the receiving-side control unit 24 sets up the information related to the electric power transmission according to the authentication command transmitted from the transmitting-side control unit 14 (Step ST16). Specifically, the NFC demodulator circuit 25C of the NFC communication unit 25 demodulates the authentication command transmitted from the transmitting-side control unit 14 and notifies it to the controller 21. Then, the controller 21 sets up, to the control register 37, various setting parameters to be used at the time of the charging control circuit 36 performing the reception control to the battery 30, according to the information related to the electric power transmission, included in the authentication command from the NFC communication unit 25, such as the transmission time and the transmission output power.

Then, the receiving-side control unit 24 notifies the transmitting-side control unit 14 of the completion of the setup of the information related to the electric power transmission (Step ST17). Specifically, the controller 21 instructs the NFC communication unit 25 to transmit a setting notification signal indicating the completion of the setup to the authentication command. The NFC modulator circuit 25B of the NFC communication unit 25 modulates the setting notification signal according to the instruction from the controller 21, and the NFC drive circuit 25A transmits the setting notification signal via the antenna 22. It is possible to include the information related to the electric power reception to the setting notification signal, such as an electric power reception level, a power supply status, a battery level, status information of a device to be supplied with electric power, and an error status.

Then, the transmitting-side control unit 14 receives the setting notification signal and completes the transmission preparation (Step ST18). Accordingly, the electric power transmission from the electric power transmitting device 10 to the electric power receiving device 20 becomes possible.

Then, the transmitting-side control unit 14 instructs the transmission start to the transmitting-side driving unit 16 (Step ST20). Specifically, the controller 2 instructs the voltage control circuit 7. The driver 8 transmits electric power to the receiving-side driving unit 26 via the antenna 12, according to the instruction from the voltage control circuit 7.

The transmitting-side driving unit 16 starts the electric power transmission according to the instruction of the electric power transmission from the transmitting-side control unit 14 (Step ST21).

Then, the receiving-side driving unit 26 receives the electric power transmitted from the transmitting-side driving unit 16 (Steps ST23 and ST24). The received electric power is charged into the battery 30 by the charging control circuit 36.

The following explains the control processing of the transmitting-side control unit 14 and the receiving-side control unit 24 in the electric power transmission and the electric power reception.

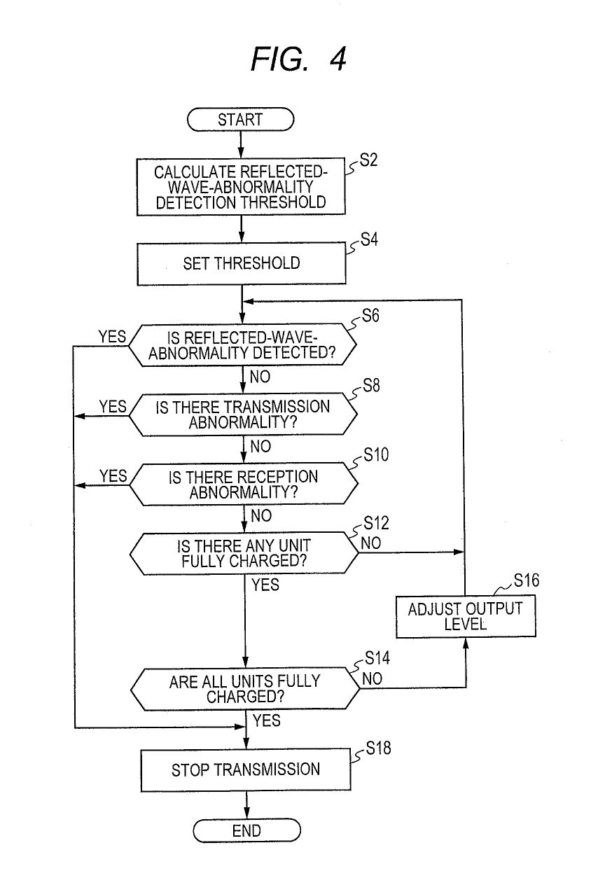

FIG. 4 is a flow chart explaining processing in transmission control of the electric power transmitting device 10 according to the present embodiment.

As illustrated in FIG. 4, first, a threshold for detecting a reflected wave abnormality (abnormality threshold) is calculated (Step S2). Specifically, the controller 2 calculates the abnormality threshold on the basis of an emitted wave potential and a reflected wave potential detected by the reflected wave detecting circuit 15 at the time of transmitting an electric power from the antenna 12 to the antenna 22.

Then, the controller 2 sets up the calculated abnormality threshold as well as a threshold (communication threshold) for extracting the reception information included in the reflected wave from the receiving side (Step S4).

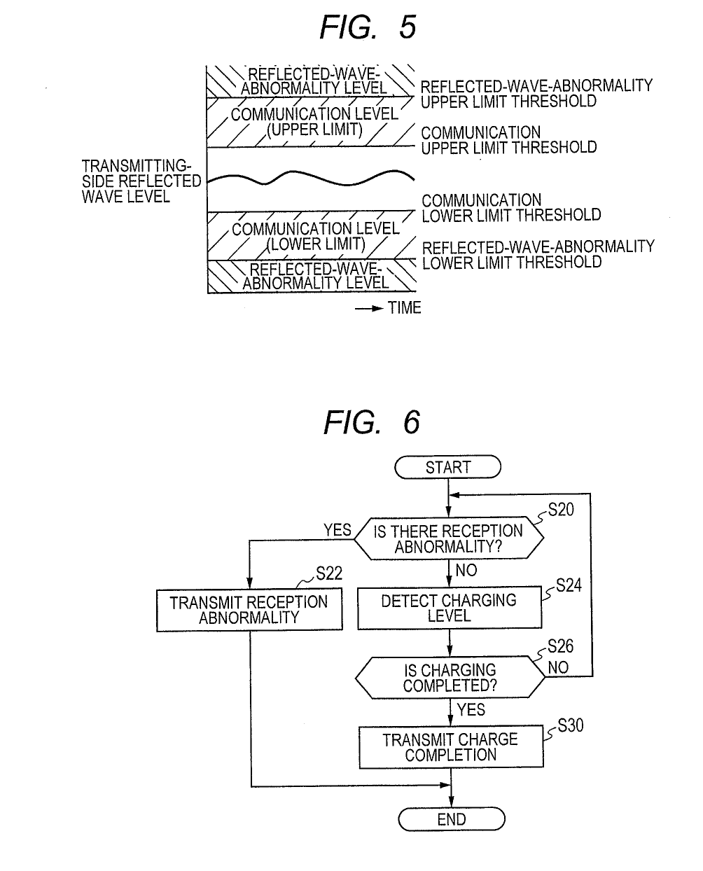

FIG. 5 is an explanatory drawing illustrating the abnormality threshold and the communication threshold according to the present embodiment. FIG. 5 illustrates the reflected wave level on the transmitting side detected by the reflected wave detecting circuit 15 in the present embodiment. Then, on the basis of the emitted wave potential and the reflected wave level (reflected wave potential) of the reflected wave received as shown in the figure, the abnormality threshold is set up by calculating a upper limit threshold for detecting the reflected wave abnormality (a reflected-wave-abnormality upper limit threshold), and a lower limit threshold for detecting the reflected wave abnormality (a reflected-wave-abnormality lower limit threshold).

It is determined that there is an abnormality when the abnormality threshold is exceeded (that is, when the upper limit threshold or the lower limit threshold is exceeded).

The reflected wave detecting circuit 15 notifies the controller 2 that there is an abnormality, when it is determined that the reflected wave level has exceeded the abnormality threshold.

The reflected wave detecting circuit 15 outputs the reflected wave level to the reception information extracting circuit 17, when the reflected wave level does not exceed the abnormality threshold. The reception information extracting circuit 17 extracts reception information from the reflected wave level if necessary.

In the present embodiment, the reception information extracting circuit 17 extracts reception information from the reflected wave level which lies between the reflected-wave-abnormality upper limit threshold and the reflected-wave-abnormality lower limit threshold.

Specifically, a threshold is calculated and set up in order to extract binary data as the reception information from the reflected wave level. With a prescribed margin to the reflected-wave-abnormality upper/lower limit threshold, a threshold (communication threshold) for detecting the binarized data (also called binary data) as the reception information is calculated as an example. In the present embodiment, an upper limit threshold (communication upper limit threshold) and a lower limit threshold (communication lower limit threshold) are set up for detecting the binary data.

Again, with reference to FIG. 4, next, the controller 2 determines whether the reflected wave abnormality is detected or not, on the basis of the detection result of the reflected wave by the reflected wave detecting circuit 15 (Step S6). Specifically, it is determined whether the reflected-wave-abnormality upper/lower limit threshold has been exceeded in the reflected wave detecting circuit 15.

At Step S6, when it is determined that no reflected wave abnormality has been detected (NO at Step S6), the controller 2 goes on to determine whether there is any transmission abnormality (Step S8). Specifically, the controller 2 determines whether an abnormality has occurred in each unit of the electric power transmitting device 10. As an example, it is determined whether a temperature abnormality has occurred, on the basis of temperature information from a temperature sensor or the like (not shown) provided in the electric power transmitting device 10, or it is determined whether any other error signal is received from each unit.

At Step S8, when it is determined that there is no transmission abnormality (NO at Step S8), the controller 2 goes on to determine whether there is any electric power reception abnormality (Step S10). Specifically, the controller 2 determines whether there is any electric power reception abnormality, on the basis of the information related to the reception state (reception information), transmitted from the electric power receiving device 20. The reception information will be described later.

At Step S10, when it is determined that there is no electric power reception abnormality (NO at Step S10), the controller 2 determines whether there is any completion of electric charging (Step S12). The controller 2 makes the present determination of whether there is any completion of the electric charging, also on the basis of the reception information.

At Step S12, when it is determined that electric charging is not completed (NO at Step S12), the controller 2 returns to Step S6 and repeats the above-described processing.

On the other hand, at Step S12, when it is determined that there is completion of electric charging (YES at Step S12), the controller 2 determines whether electric charging has been completed for all units of the electric power receiving devices (Step S14).

When it is determined that the electric charging has not completed for all units (NO at Step S14), the controller 2 adjusts the output level (Step S16). Specifically, when the number of electric power receiving devices to be charged is changed, the controller 2 instructs the voltage control circuit 7 to adjust the transmission output power corresponding to the number of electric power receiving devices. It is possible to suppress wasteful consumption of the electric power by decreasing transmission output power as the number of electric power receiving devices decreases.

Then, returning to Step S6 and the above-described processing is repeated. The present embodiment explains the method which adjusts the transmission output power when the number of electric power receiving devices is changed. However, when the reception conditions on the side of the electric power receiving device is also changed due to the change in the number of electric power receiving devices, it is preferable to stop the electric power transmission once and to execute again the device authentication processing explained above, thereby changing the reception conditions.

On the other hand, at Step S14, when it is determined that the electric charging has completed for all the units (YES at Step S14), the controller 2 stops the electric power transmission (Step S18).

Then, the processing is terminated (End). Specifically, the controller 2 instructs the voltage control circuit 7 to stop the supply of voltage to the driver 8. Accordingly the electric power transmission to the electric power receiving device is stopped.

On the other hand, at Step S6, when it is determined that a reflected wave abnormality has been detected (YES at Step S6), or at Step S8, when it is determined that there is a transmission abnormality (YES at Step S8), or at Step S10, when it is determined that there is an electric power reception abnormality (YES at Step S10), the controller 2 stops the electric power transmission (Step S18). Then, the processing is terminated (End).

FIG. 6 is a flowchart explaining processing in reception control of the electric power receiving device 20 according to the present embodiment.

As illustrated in FIG. 6, the controller 21 determines whether there is an electric power reception abnormality (Step S20). Specifically, the controller 21 determines whether an abnormality has occurred in each unit of the electric power receiving device 20. As an example, it is determined whether a temperature abnormality has occurred, on the basis of temperature information from a temperature sensor or the like (not shown) provided in the electric power transmitting device 10, or it is determined whether any other error signal is received from each unit.

At Step S20, when it is determined that there is no electric power reception abnormality (NO at Step S20), the controller 21 goes on to detect a charging level (Step S24). Specifically, the charging control circuit 36 detects a charging level which indicates the charging state of the battery 30, and outputs the charging level to the controller 21.

Next, the controller 21 determines whether the electric charging of the battery 30 has completed, on the basis of the detected charging level (Step S26).

At Step S26, when it is determined that electric charging of the battery 30 is not completed (NO at Step S26), the controller 21 returns to Step S20 and repeats the above-described processing.

On the other hand, at Step S26, when it is determined that the electric charging of the battery 30 has completed (YES at Step S26), the controller 21 transmits charge completion as the reception information (Step S30). Specifically, the controller 21 changes the capacitance value of the variable capacitor (VC) 31 to change the resonance frequency. The change will be described later.

Then, the processing is terminated (End). On the other hand, at Step S20, when it is determined that there is an electric power reception abnormality (YES at Step S20), the controller 21 transmits the electric power reception abnormality as the reception information (Step S22). Specifically, the controller 21 changes the capacitance value of the variable capacitor (VC) 31 to change the resonance frequency. The change will be described later.

Then, the processing is terminated (End). It is also preferable to change the capacitance value of the variable capacitor (VC) 31 to shift the resonance frequency greatly, after transmitting the electric power reception abnormality, or after transmitting the charge completion. That is, it is also possible to adjust the frequency out of tune with the transmitting resonance coil of the electric power transmitting device 10, so as to decrease the reception of the electric power transmitted from the electric power transmitting device 10, thereby making the influence low.

In the present embodiment, when a prescribed condition is satisfied, the information related to the reception state (reception information) is transmitted from the electric power receiving device 20 to the electric power transmitting device 10.

Specifically, when the prescribed condition is satisfied (for example, when a reception abnormality occurs, or when the electric charging is completed), a capacitance value of the variable capacitor 31 is adjusted according to a prescribed pattern.

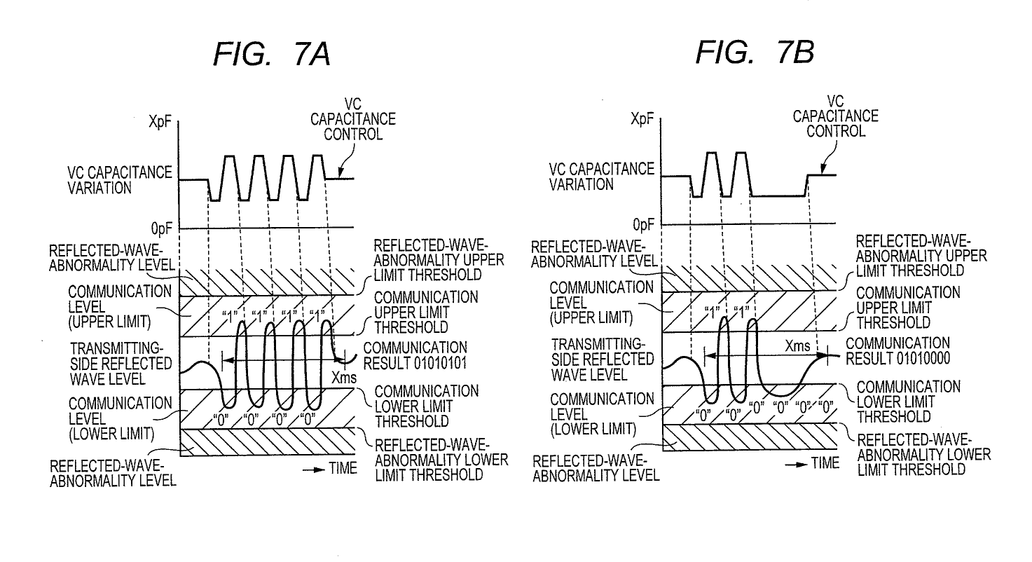

FIGS. 7A and 7B are explanatory drawings illustrating adjustment of the capacitance value of the variable capacitor 31 according to the present embodiment.

FIG. 7A illustrates a case where the capacitance value of the variable capacitor 31 is varied up and down in a prescribed pattern. That is, the resonance frequency specified by the capacitance value is adjusted. According to the adjustment of the resonance frequency, the reflected wave level varies up and down.

Specifically, the controller 21 adjusts a voltage value applied to the variable capacitor (VC) 31 to adjust the capacitance value. In the present embodiment, the controller 21 repeats the processing in which the voltage value applied to the variable capacitor 31 is increased or decreased according to the prescribed pattern, thereby varying the capacitance value up and down.

In the present embodiment, it is assumed that a prescribed pattern is stored in advance and that the capacitance value of the variable capacitor (VC) 31 is varied according to the prescribed pattern, corresponding to the occurrence of an event that the prescribed condition has been satisfied or the electric charging has completed. Specifically, it is assumed that the information related to the prescribed pattern is stored in the memory 23 of the receiving-side control unit 24 of the electric power receiving device 20. The controller 21 varies the capacitance value of the variable capacitor 31 up and down according to the prescribed pattern stored in the memory 23. That is, the controller 21 adjusts the frequency.

Then, when the capacitance value of the variable capacitor 31 is varied, the signal level of the reflected wave is varied up and down, and the reception information extracting circuit 17 extracts the reception information included in the reflected wave. Specifically, the reception information extracting circuit 17 detects data, when the upper limit threshold or the lower limit threshold of the communication threshold set up in advance is exceeded. In the present embodiment, an example is shown for the case where the lower limit of the communication threshold is exceeded first.

As an example, it is assumed that the reception information extracting circuit 17 detects “0” when the lower limit threshold of the communication threshold is exceeded (underrun). On the other hand, it is assumed that the reception information extracting circuit 17 detects “1” when the upper limit threshold of the communication threshold is exceeded (overrun).

In the present embodiment, an example is shown for the case where 8-bit binary data “01010101” is detected as the reception information.

In the present embodiment, the binary data within a prescribed period after the data detection is detected, then, it is determined whether the binary data specified in advance as the reception information is received from the electric power receiving device. In the present embodiment, it is assumed that data indicative of charge completion (charge completion data) “01010101” is registered in the memory 2A. Then, the controller 2 determines whether the binary data “01010101” detected as the reception information coincides with the specified data which is registered in the memory 2A. In the present embodiment, it is now assumed to determine that the binary data detected as the reception information coincides with the charge completion data registered in the memory 2A.

The controller 2 of the electric power transmitting device 10 determines that the reception state of the electric power receiving device 20 is the charge completion, on the basis of the reception information (binary data).

Following this, when it is determined that the electric charging has completed for all the units of the electric power receiving devices, the controller 2 of the electric power transmitting device 10 instructs the voltage control circuit 7 to stop the supply of voltage. Accordingly the electric power transmission is stopped.

FIG. 7B illustrates another case where the capacitance value of the variable capacitor 31 is varied up and down in a prescribed pattern. That is, the resonance frequency specified by the capacitance value is adjusted. According to the adjustment of the resonance frequency, the reflected wave level varies up and down.

Specifically, the controller 21 adjusts a voltage value applied to the variable capacitor (VC) 31 to adjust the capacitance value. In the present embodiment, the controller 21 repeats the processing in which the voltage value applied to the variable capacitor 31 is increased or decreased according to the prescribed pattern, thereby varying the capacitance value up and down.

In the present embodiment, it is assumed that a prescribed pattern is stored in advance and that the capacitance value of the variable capacitor (VC) 31 is varied according to the prescribed value, corresponding to the occurrence of an event that the prescribed condition has been satisfied or an abnormality has occurred in the electric power receiving device 20. Specifically, it is assumed that the information related to the prescribed pattern is stored in the memory 23 of the receiving-side control unit 24 of the electric power receiving device 20. The controller 21 varies the capacitance value of the variable capacitor 31 up and down according to the prescribed pattern stored in the memory 23. That is, the controller 21 adjusts the frequency.

Then, when the capacitance value of the variable capacitor 31 is varied, the signal level of the reflected wave is varied up and down, and the reception information extracting circuit 17 extracts the reception information included in the reflected wave. Specifically, the reception information extracting circuit 17 detects data, when the upper limit threshold or the lower limit threshold of the communication threshold set up in advance is exceeded. In the present embodiment, an example is shown for the case where the lower limit of the communication threshold is exceeded first.

In the present embodiment, an example is shown for the case where 8-bit binary data “01010000” is detected as the reception information.

In the present embodiment, the binary data within a prescribed period after the data detection is detected, then, it is determined whether the binary data specified in advance as the reception information is received from the electric power receiving device. In the present embodiment, it is assumed that data indicative of an electric power reception abnormality (reception abnormality data) “01010000” is registered in the memory 2A. Then, the controller 2 determines whether the binary data “01010000” detected as the reception information coincides with the specified data which is registered in the memory 2A. In the present embodiment, it is now assumed to determine that the binary data detected as the reception information coincides with the reception abnormality data registered in the memory 2A.

The controller 2 of the electric power transmitting device 10 determines that the reception state of the electric power receiving device 20 is the electric power reception abnormality, on the basis of the reception information (binary data).

Following this, the controller 2 of the electric power transmitting device 10 instructs the voltage control circuit 7 to stop the supply of voltage. Accordingly the electric power transmission is stopped.

In the case where plural electric power receiving devices exist, when it is determined that a certain electric power receiving device is in the state of an electric power reception abnormality, it is preferable to stop the electric power transmission. Alternatively, it is also preferable to change the number of electric power receiving devices to be charged (to reduce the number of electric power receiving devices) so that other electric power receiving devices may not be affected, and to instruct the voltage control circuit 7 to adjust the transmission output power depending on the number of electric power receiving devices.

The charge completion data and the reception abnormality data described above are only an example, and it is naturally possible to specify the reception information in terms of other data.

By employing the method according to the present embodiment, it is possible to transmit the information on the reception state from the electric power receiving device to the electric power transmitting device by a simple means, while performing the electric power transmission, or performing the electric power reception. Therefore, it is not necessary to stop the electric power transmission in order to communicate, and it is possible to reduce the time required for electric charging. When processing which repeats stop and start of the electric power transmission is performed, it is difficult to efficiently transmit electric power. However, by employing the method according to the present embodiment, it is possible to establish communications while continuing the electric power transmission, resulting in the efficient transmission of the electric power.

The transmission control is executed on the basis of the command which is the reception information from the electric power receiving device. Accordingly, it is possible to perform the control instantaneously.

The present embodiment explains the case where the reception abnormality data or the charge completion data as the reception information is transmitted from the electric power receiving device to the electric power transmitting device, and the electric power transmitting device detects the reception information to perform the transmission control on the basis of the detection result. However, the reception information is not restricted to the above, and it is also possible to transmit another kind of reception information.

Specifically, it is also possible to transmit the charging level in the charging state of the battery 30 as the reception information to the electric power transmitting device.

Then, the transmission output power from the electric power transmitting device may be adjusted depending on the charging state of the battery 30. As an example, when the charging state is at a low level, the transmission output power is increased stepwise, or when the charging state is close to the charge completion, the transmission output power is decreased stepwise. In this way, it is also possible to efficiently execute the transmission control.

In the case of charging plural units of electric power receiving devices in parallel, by including the identification information of an electric power receiving device in the reception information, it is possible to identify which electric power receiving device has completed electric charging. It is also preferable, when an abnormality occurs, to identify which electric power receiving device has the abnormality and to notify the fact to the higher-order system.

It is possible not only to transmit the reception state from the electric power receiving device to the electric power transmitting device at the time of occurrence of an event, such as the occurrence of an abnormality or the completion of electric charging, but it is also possible to transmit the reception information for every prescribed period from the electric power receiving device to the electric power transmitting device, thereby allowing for the electric power transmitting device to monitor periodically the state of the electric power receiving device.

The description given above has explained the case where the information mainly related to the reception state is transmitted as the reception information; however, any kind of information, such as a reception period and an electric power reception level, may be transmitted, as long as it is information related to the electric power reception.

### Modified Example of Embodiment

The embodiment described above has explained the case where the communication threshold is set up in order to extract the reception information, and the reception information is extracted from the reflected wave, by detecting data “1” or “0” when the upper or lower limit of the communication threshold is exceeded.

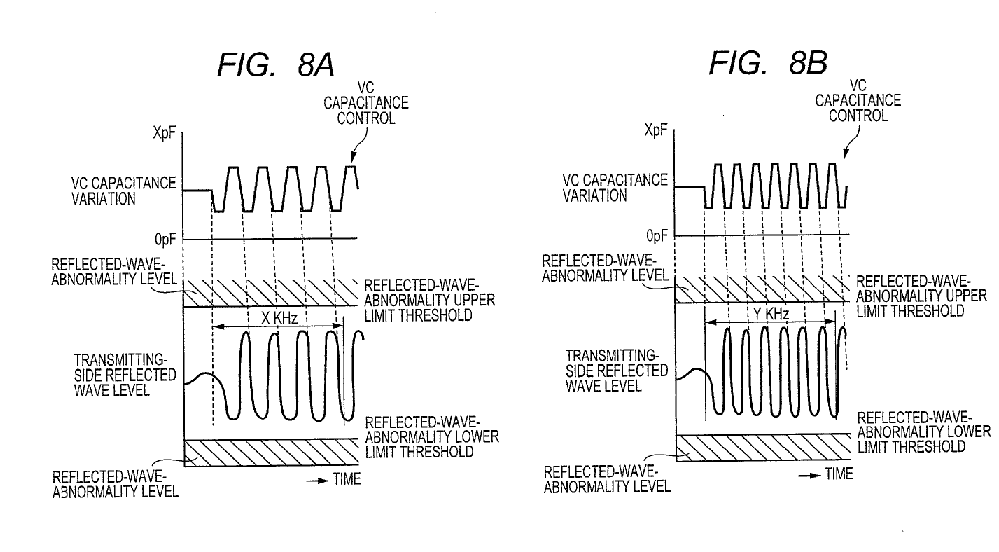

On the other hand, it is possible to detect data without providing the communication threshold. FIGS. 8A and 8B are explanatory drawings illustrating adjustment of a capacitance value of the variable capacitor according to a modified example of the present embodiment.

FIG. 8A illustrates a case where the capacitance value of the variable capacitor 31 is varied up and down according to a prescribed pattern. That is, the resonance frequency specified by the capacitance value is adjusted. According to the adjustment of the resonance frequency, the reflected wave level varies up and down.

Specifically, the controller 21 adjusts a voltage value applied to the variable capacitor (VC) 31 to adjust the capacitance value. In the present embodiment, the controller 21 repeats the processing in which the voltage value applied to the variable capacitor 31 is increased or decreased according to the prescribed pattern, thereby varying the capacitance value up and down.

In the present embodiment, it is assumed that a prescribed pattern is stored in advance and the capacitance value of the variable capacitor (VC) 31 is varied according to the prescribed pattern, corresponding to the occurrence of an event that the prescribed condition has been satisfied or the electric charging has completed. Specifically, it is assumed that the information related to the prescribed pattern is stored in the memory 23 of the receiving-side control unit 24 of the electric power receiving device 20. The controller 21 varies the capacitance value of the variable capacitor 31 up and down according to the prescribed pattern stored in the memory 23. That is, the controller 21 adjusts the frequency.

Then, when the capacitance value of the variable capacitor 31 is varied, the signal level of the reflected wave is varied up and down, and the reception information extracting circuit 17 extracts the reception information included in the reflected wave. Specifically, the reception information extracting circuit 17 extracts the frequency of the signal level of the reflected wave. Specifically, the reception information extracting circuit 17 performs Fourier transform of an A/D conversion result of the signal level of the reflected wave, and detects the frequency of the signal level of the reflected wave.

In the present embodiment, an example is shown for the case where the frequency of X kHz is detected as the reception information.

In the present embodiment, it is determined whether the reflected wave having the frequency specified in advance has been received as the reception information from the electric power receiving device, by detecting the frequency of the signal level of the reflected wave within a prescribed period. In the present embodiment, it is assumed that the frequency data of X kHz as the data indicative of charge completion (charge completion data) is registered in the memory 2A. Then, the controller 2 determines whether the frequency of X kHz detected as the reception information coincides with the specified frequency data which is registered in the memory 2A. In the present embodiment, it is now assumed to determine that the frequency detected as the reception information coincides with the charge completion data (X kHz) registered in the memory 2A.

The controller 2 of the electric power transmitting device 10 determines that the reception state of the electric power receiving device 20 is the charge completion, on the basis of the reception information.

Following this, when it is determined that the electric charging has completed for all the units of the electric power receiving devices, the controller 2 of the electric power transmitting device 10 instructs the voltage control circuit 7 to stop the supply of voltage. Accordingly the electric power transmission is stopped.

FIG. 8B illustrates another case where the capacitance value of the variable capacitor 31 is varied up and gown as a prescribed pattern. That is, the resonance frequency specified by the capacitance value is adjusted. According to the adjustment of the resonance frequency, the reflected wave level varies up and down.

Specifically, the controller 21 adjusts a voltage value applied to the variable capacitor (VC) 31 to adjust the capacitance value. In the present embodiment, the controller 21 repeats the processing in which the voltage value applied to the variable capacitor 31 is increased or decreased according to the prescribed pattern, thereby varying the capacitance value up and down.

In the present embodiment, it is assumed that a prescribed pattern is stored in advance and the capacitance value of the variable capacitor (VC) 31 is varied according to the prescribed pattern, corresponding to the occurrence of an event that the prescribed condition has been satisfied or the electric charging has completed. Specifically, it is assumed that the information related to the prescribed pattern is stored in the memory 23 of the receiving-side control unit 24 of the electric power receiving device 20. The controller 21 varies the capacitance value of the variable capacitor 31 up and down according to the prescribed pattern stored in the memory 23. That is, the controller 21 adjusts the frequency.

Then, when the capacitance value of the variable capacitor 31 is varied, the signal level of the reflected wave is varied up and down, and the reception information extracting circuit 17 extracts the reception information included in the reflected wave. Specifically, the reception information extracting circuit 17 extracts the frequency of the signal level of the reflected wave. Specifically, the reception information extracting circuit 17 performs Fourier transform of an A/D conversion result of the signal level of the reflected wave, and detects the frequency of the signal level of the reflected wave.

In the present embodiment, an example is shown for the case where the frequency of Y kHz is detected as the reception information.

In the present embodiment, it is determined whether the reflected wave having the frequency specified in advance has been received as the reception information from the electric power receiving device, by detecting the frequency of a signal level of the reflected wave within a prescribed period. In the present embodiment, it is assumed that the frequency data of Y kHz as the data indicative of an electric power reception abnormality (reception abnormality data) is registered in the memory 2A. Then, the controller 2 determines whether the frequency of Y kHz detected as the reception information coincides with the specified frequency data which is registered in the memory 2A. In the present embodiment, it is now assumed to determine that the frequency detected as the reception information coincides with the reception abnormality data (Y kHz) registered in the memory 2A.

The controller 2 of the electric power transmitting device 10 determines that the reception state of the electric power receiving device 20 is the electric power reception abnormality, on the basis of the reception information.

Following this, the controller 2 of the electric power transmitting device 10 instructs the voltage control circuit 7 to stop the supply of voltage. Accordingly the electric power transmission is stopped.

In the case where plural electric power receiving devices exist, when it is determined that a certain electric power receiving device is in the state of an electric power reception abnormality, it is preferable to stop the electric power transmission. Alternatively, it is also preferable to change the number of electric power receiving devices to be charged (to reduce the number of electric power receiving devices) so that other electric power receiving devices may not be affected, and to instruct the voltage control circuit 7 to adjust the transmission output power depending on the number of electric power receiving devices.

The charge completion data and the reception abnormality data described above are only an example, and it is naturally possible to specify the reception information in terms of other data.

As described above, the invention accomplished by the present inventors has been concretely explained based on embodiments. However, it cannot be overemphasized that the present invention is not restricted to the embodiments, and it can be changed variously in the range which does not deviate from the gist.

What is claimed is:

1. A non-contact charging system comprising:
an electric power transmitting device operable to perform electric power transmission at a resonance frequency by employing a transmitting resonance coil; and
an electric power receiving device operable to perform electric power reception at the resonance frequency by employing a receiving resonance coil,
wherein the electric power receiving device comprises:
an adjustment unit operable to adjust the resonance frequency of the receiving resonance coil; and
a receiving-side control unit operable to instruct the adjustment unit to adjust the resonance frequency in accordance with a prescribed pattern, when a prescribed condition is satisfied, and
wherein the electric power transmitting device comprises:
a reflected wave detection unit operable to detect a reflected wave from the electric power receiving device accompanying the electric power transmission;
an extraction unit operable to extract reception information included in the reflected wave, detected by the reflected wave detection unit and changing with the adjustment of the resonance frequency; and
a transmitting-side control unit operable to control the electric power transmission from the transmitting resonance coil on the basis of the reception information extracted by the extraction unit.

2. The non-contact charging system according to claim 1,
wherein the adjustment unit comprises:
a variable capacitor provided in parallel with the receiving resonance coil and having a capacitance value variable in accordance with the instruction from the receiving-side control unit.

3. The non-contact charging system according to claim 1,
wherein the reflected wave detection unit detects an abnormality, when the reflected wave exceeds a prescribed range.

4. The non-contact charging system according to claim 1,
wherein the extraction unit extracts binary data from the reflected wave changing in accordance with the adjustment of the resonance frequency, and
wherein the transmitting-side control unit controls the electric power transmission from the transmitting resonance coil on the basis of the binary data extracted by the extraction unit.

5. The non-contact charging system according to claim 1,
wherein the extraction unit extracts frequency data of the reflected wave changing in accordance with the adjustment of the resonance frequency, and
wherein the transmitting-side control unit controls the electric power transmission from the transmitting resonance coil on the basis of the frequency data extracted by the extraction unit.

6. The non-contact charging system according to claim 1,
wherein the transmitting-side control unit controls the level of an electric power to be transmitted from the transmitting resonance coil to the receiving resonance coil on the basis of the reception information.

7. The non-contact charging system according to claim 1,
wherein the transmitting-side control unit stops the electric power transmission from the transmitting resonance coil on the basis of the reception information.

8. A non-contact charging method employing a transmitting resonance coil for performing electric power transmission at a resonance frequency and a receiving resonance coil for performing electric power reception at the resonance frequency, the non-contact charging method comprising the steps of:
adjusting the resonance frequency of the receiving resonance coil in accordance with a prescribed pattern when a prescribed condition is satisfied;
detecting a reflected wave accompanying the electric power transmission to the receiving resonance coil;
extracting reception information included in the detected reflected wave changing with the adjustment of the resonance frequency; and
controlling the electric power transmission from the transmitting resonance coil on the basis of the extracted reception information.
